(19) United States
(12) Patent Application Publication
(10) Pub. No.: US 2015/0081470 A1
(43) Pub. Date: Mar. 19, 2015

(54) METHODS AND APPARATUS FOR PROVIDING SUPPLEMENTAL CONTENT IN COMMUNICATIONS SHARING A WEBPAGE

(71) Applicant: W.W. GRAINGER, INC., Lake Forest, IL (US)

(72) Inventor: Geoffry A. Westphal, Evanston, IL (US)

(73) Assignee: W.W. GRAINGER, INC., Lake Forest, IL (US)

(21) Appl. No.: 14/030,222

(22) Filed: Sep. 18, 2013

(51) Int. Cl. G06Q 50/00; G06Q 30/06

(52) U.S. Cl. CPC G06Q 50/01; G06Q 30/0631
USPC 705/26.7

(57) ABSTRACT

An apparatus and methods are provided for personalizing messages that are sent to a recipient when a user of a website wishes to “share” a particular webpage or content thereof with the recipient. The apparatus and methods, which are founded on non-transitory computer readable media, involve using information available about the recipient as well as information about a product or service displayed on the webpage to identify supplemental content to include in the message to the recipient regarding the shared webpage. The recipient's prior browsing and purchasing histories with the website, as well as the purchasing tendencies of other customers, may be particularly helpful in identifying relevant supplemental content.

### FIELD OF THE DISCLOSURE

The present disclosure relates generally to e-commerce and, more particularly, to methods and apparatus for providing supplemental content in communications sharing a webpage or content thereof.

### BACKGROUND OF RELATED ART

It is known that users of websites share webpages or specific content from those webpages with others. Typically, a user of a website will select a “share” button on a webpage and enter a name or an email of a recipient with which the user wishes to share the webpage. The website then sends the recipient an email or other communication containing a hyperlink to the webpage shared by the user. As of now, however, there is no known way to provide the recipient with supplemental content that is relevant to the content of the shared webpage, much less supplemental content that is based on the interests of the recipient.

### BRIEF DESCRIPTION OF THE DRAWINGS

For a better understanding of the disclosed methods and apparatus for providing supplemental content in communications sharing a webpage or content thereof, reference may be had to examples shown in the following drawings.

FIG. 1 is a block diagram illustrating components of an example network system in which the disclosed systems may be employed.

FIG. 2 illustrates an example webpage of an example website that a user may choose to “share” with a recipient or social network.

FIG. 3 is a flowchart of an example method that represents one possible way of identifying and sharing supplemental content intended to complement a webpage or content thereof that a user has shared.

### DETAILED DESCRIPTION

To address the aforementioned need and other needs, disclosed hereinafter are methods and apparatus that identify supplemental content to be included in communications sharing a webpage or some content thereof. In many instances, the content of the webpage concerns a product or service offered by a website. After a user of a website clicks a “share” button on the webpage or otherwise activates a sharing function, the website may prompt the user to enter information identifying one or more recipients with which the user wishes to share the webpage. A system operating the website may then collect all available information regarding the recipient, including without limitation the recipient's prior browsing history and prior purchase history with the website. The system may then input the collected information and an identifier associated with the content of the webpage to a recommendation engine.

The recommendation engine may consider a number of factors to determine which products or services offered by the website or a third party would be most helpful to the recipient of a message sharing the webpage. Some example factors that the recommendation engine considers include for each product or service offered by the website a percentage of customers that have purchased that product or that service when they purchased the product or service of the webpage being shared, the relatedness of a good or service to the product or service of the webpage being shared, a cost of the product or service of the webpage being shared, a typical ordered quantity of the product or service of the webpage being shared, a recipient's prior purchases at the website, and a recipient's prior browsing history at the website. Based on factors such as these, the recommendation engine identifies supplemental content, such as one or more products or services, which complements the product or service being shared with the recipient. In many instances, the supplemental content is a product or service that is required for use of the product or service featured on the shared webpage.

The following description of example methods and apparatus is not intended to limit the scope of the disclosure to the precise form or forms detailed herein. Instead the following disclosure is intended to be illustrative so that others may follow its teachings.

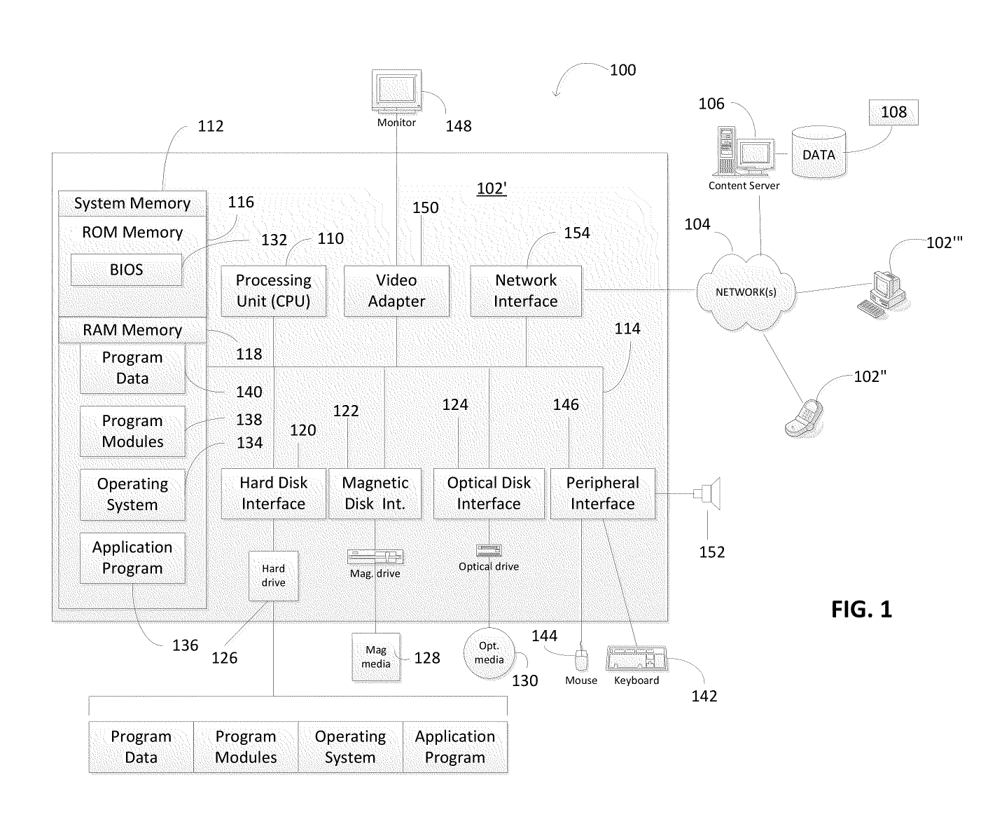

As illustrated in FIG. 1, a system 100 will be described in the context of a plurality of example processing devices 102 linked via a network 104, such as the World Wide Web or the Internet. In this regard, a user processing device 102′ illustrated in the example form of a computer system, a user processing device 102″ illustrated in the example form of a mobile device, or a user processing device 102′″ illustrated in the example form of a personal computer provide a means for a user to access a website content server 106 via the network 104 and thereby gain access to content such as media, data, webpages, an electronic catalog, etc., stored in a repository 108 associated with the content server 106. Although only one of the processing devices 102 is shown in detail in FIG. 1, it will be understood that in some examples the user processing device 102′ shown in detail may be representative, at least in part, of the other user processing devices 102″, 102′″, including those that are not shown.

Furthermore, the website content server 106 and/or the user processing devices 102 allow users to read and/or write data from/to the website content server 106. A user's interactions with the content offered by a website are stored in the repository 108 associated with the content server 106 and are further indexed to a particular user (e.g., using log-in information, an internet protocol (IP) address, or other information that the content server 106 may utilize to identify the user or at least a device). Storing such information can be accomplished, for example, by monitoring user interactions with a website during web browsing sessions by recording events, accessed content, and other data such as the following: keyword searches; model number searches; stock-keeping unit (SKU) searches; selection guides; clicked links; links that a user's mouse hovered over for any measurable period of time; accessed menus; products viewed; number of products reviewed; product images that were magnified; product comparisons; times during which webpages by using log-in credentials and/or other content was viewed or accessed; duration of stay; dialogs of chat sessions; audio recordings of telephonic conversations between the user and a customer service representative; identities of employees with which the user interacts; notes from users, peers (e.g., another company employee or an employee from another company), service representatives, or technical representatives; lists of products generated by users; order histories; quantities of each product ordered; pending orders; user alerts; user preferences; personal information (e.g., created by or provided for the user); or information that the content server 106 may utilize to identify the user. In short, the system 100 may in some examples record virtually all aspects regarding users' visits to the website and/or other relevant network activity.

In addition to storing information regarding a user's visits to the website, the content server 106 and/or the repository 108 associated with the content server 106 may also contain a collection of documents or other content that may be identified and provided as supplemental content, as disclosed below. In some examples, such content may concern without limitation news, events, how-to guides, part manuals, instruction manuals, and/or other information.

In another example, the information relevant to the user's interactions with the content offered by the website may also or alternatively be stored on the user processing devices 102 and/or other storage media local to the device 102, for example, in cases where a user has not logged into the website content server 106 and is anonymously navigating the content provided by the website content server 106. In this case, users' interactions with the web content offered by the website content server 106 may be stored, for example, in cookies and/or other temporary or persistent files placed on the user processing devices 102 using well known techniques. Because the manner by which the user processing devices 102 are used to access and navigate the website offered by the website content server 106, the manner by which the website content server 106 makes content available to the user devices 102, and the manner by which the website usage is monitored—are all well known in the art, they will not be discussed further herein for the sake of brevity.

For performing the functions required of the user processing devices 102 and the content server 106, the user processing devices 102 and the content server 106 include computer executable instructions that reside in program modules stored on any non-transitory computer readable storage medium that may include routines, programs, objects, components, data structures, etc. that perform particular tasks or implement particular abstract data types. Accordingly, one of ordinary skill in the art will appreciate that the user processing devices 102 and the content server 106 may be any device having the ability to execute instructions such as, by way of example, a personal computer, mainframe computer, personal-digital assistant (PDA), tablet, cellular telephone, mobile device, e-reader, or the like. Furthermore, while the user processing devices 102 and the content server 106 within the system 100 are illustrated as respective single devices, those having ordinary skill in the art will also appreciate that the various tasks described hereinafter may be practiced in a distributed environment involving multiple processing devices linked via a local or wide-area network whereby the executable instructions may be associated with and/or executed by one or more of multiple processing devices.

More particularly, the user processing device 102′, which may be representative of all user processing devices 102 and the content server 106 illustrated in FIG. 1, performs various tasks in accordance with the executable instructions. Thus the example user processing device 102′ includes one or more processing units 110 and a system memory 112, which may be linked via a bus 114. Without limitation, the bus 114 may be a memory bus, a peripheral bus, and/or a local bus using any of a variety of well-known bus architectures. As needed for any particular purpose, the example system memory 112 includes read only memory (ROM) 116 and/or random access memory (RAM) 118. Additional memory devices may also be made accessible to the processing device 102′ by means of, for example, a hard disk drive interface 120, a removable magnetic disk drive interface 122, and/or an optical disk drive interface 124. As will be understood, these devices, which may be linked to the system bus 114, respectively allow for reading from and writing to a hard drive 126, reading from or writing to a removable magnetic disk 128, and for reading from or writing to a removable optical disk 130, such as a CD/DVD ROM or other optical media. The drive interfaces and their associated tangible, computer-readable media allow for the nonvolatile storage of computer readable instructions, data structures, program modules and other data for the user processing device 102′. Those of ordinary skill in the art will further appreciate that other types of tangible, computer readable media that can store data may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices. For example, a basic input/output system (BIOS) 132, containing the basic routines that help to transfer information between elements within the user processing device 102′, such as during start-up, may be stored in the ROM 116. Similarly, the RAM 118, the hard drive 126, and/or the peripheral memory devices may be used to store computer executable instructions comprising an operating system 134, one or more applications programs 136 (such as a Web browser), other program modules 138, and/or program data 140. Still further, computer-executable instructions may be downloaded to one or more of the computing devices as needed, for example, via a network connection.

A user may enter commands and information into the user processing device 102′ through input devices such as a keyboard 142 and/or a pointing device 144 (e.g., a computer mouse). While not illustrated, other input devices may include for example a microphone, a joystick, a game pad, a scanner, a touchpad, a touch screen, a motion sensing input, etc. These and other input devices may be connected to the processing unit 110 by means of an interface 146 which, in turn, may be coupled to the bus 114. Input devices may be connected to the processor 110 using interfaces such as, for example, a parallel port, game port, firewire, universal serial bus (USB), or the like. To receive information from the user processing device 102′, a monitor 148 or other type of display device may also be connected to the bus 114 via an interface, such as a video adapter 150. In addition to the monitor 148, the user processing device 102′ may also include other peripheral output devices such as a speaker 152.

As further illustrated in FIG. 1, the example user processing device 102′ has logical connections to one or more remote computing devices, such as the content server 106 which, as noted above, may include many or all of the elements described above relative to the user processing device 102′ as needed for performing its assigned tasks. By way of further example, the website content server 106 may include executable instructions stored on a non-transient memory device for, among other things, presenting webpages, handling search requests, providing search results, providing access to context related services, redeeming coupons, sending emails, managing lists, managing databases, generating tickets, presenting requested user specific information, generating deals, etc. Communications between the user processing device 102′ and the content server 106 may be exchanged via a further processing device, such as a network router (not shown), that is responsible for network routing. Communications with the network router may be performed via a network interface component 154. Thus within such a networked environment (e.g., the Internet, World Wide Web, LAN, or other like type of wired or wireless network), it will be appreciated that program modules depicted relative to the user processing device 102′, or portions thereof, may be stored in the repository 108 of the content server 106. Additionally, it will be understood that, in certain circumstances, various data of the application and/or data utilized by the content server 106 and/or the user processing device 102′ may reside in the “cloud.”

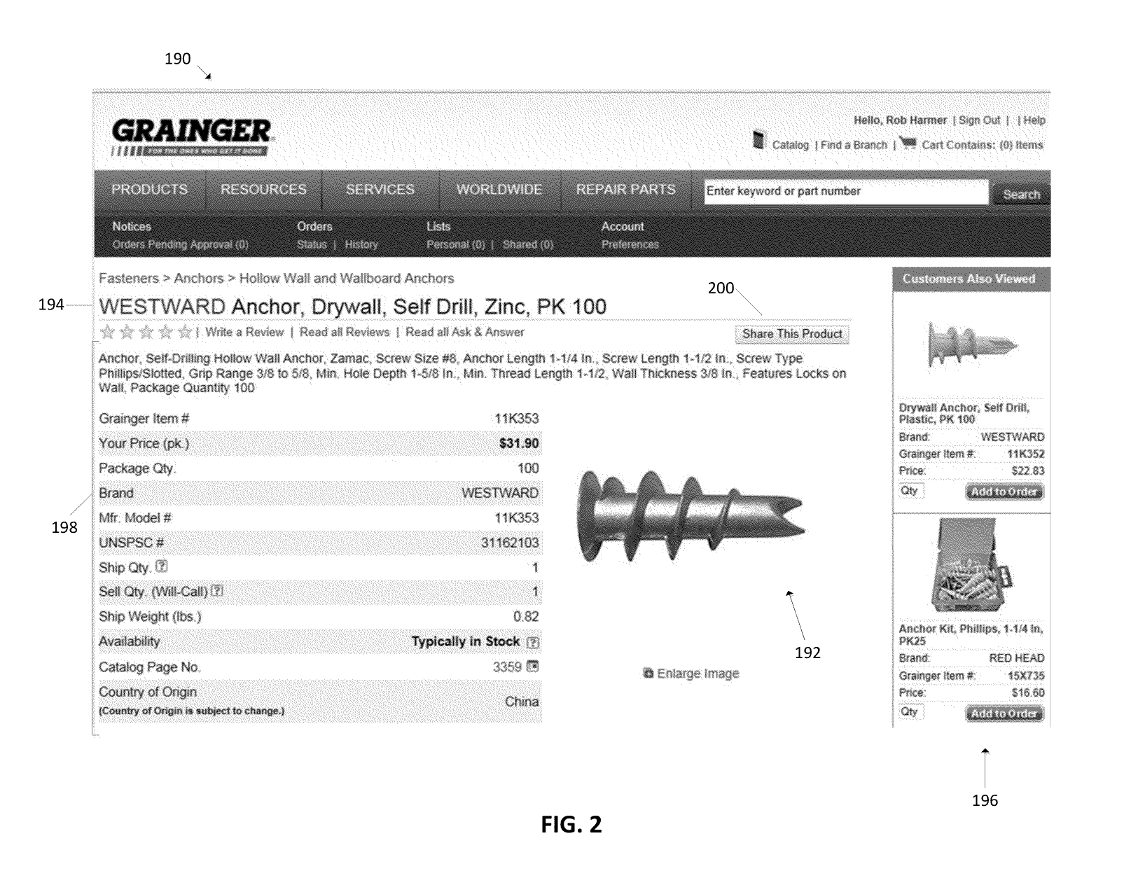

Turning now to FIG. 2, part of an example webpage 190 of a website is shown that can be used with the system 100 of FIG. 1. In some examples, the website is associated with the website content server 106 and the repository 108 disclosed above. In this example, the example webpage 190 includes a variety of information about a product sold by a vendor of facilities maintenance products. That information includes, for instance, an image 192 of the product, a title 194 of the product, recommended products 196, and other specifications 198 related to the product.

To allow users to share content from the webpage 190 with others, the example webpage 190 also includes a share button 200 or other sharing mechanism or sharing indicator that users can select or otherwise activate. In this example, the share button 200 may be configured in a number of ways. In one example, for instance, selection of the share button 200 cause the system 100 to load a second webpage (not shown) in response to a user selecting the share button 200 on the webpage 190. The second webpage may prompt the user to enter some identifying information (e.g., email, phone number, name, user name, customer number, address) of a recipient so that the system 100 can send a message regarding the webpage 190 to the recipient. In another example, however, clicking the share button 200 on the webpage 190 may cause a pop-up or other modal or non-modal child window to appear that prompts the user for identifying information about the recipient(s). In some examples, the website may prompt the user to select from a list of social networking sites such as Facebook®, Twitter®, Google+™, LinkedIn®, Reddit®, StumbleUpon®, Delicious™, Tumblr®, and so on. Upon selecting one or more social networking sites, the user may specify whether the webpage 190 should be shared with a particular recipient, shared with multiple recipients, or shared generally.

Those having ordinary skill in the art will understand that although there is only one share button 200 on the example webpage 190, some webpages may have more than one share button, particularly where a webpage includes a variety of content. In such instances, users of the website may choose to share specific portions of a webpage, rather than an entire webpage. Thus, for the sake of brevity and unless specified otherwise, it should be understood that where the present disclosure refers to sharing “a webpage,” such reference may mean sharing an entire webpage or sharing specific content from a webpage. In either case, such content may generally be referred to as “primary” content.

The share button 200 may come in a variety of shapes and sizes, and may be represented by various different textual expressions. In some examples, the share button 200 may not necessarily resemble a “button,” but may be posed to the user of the website in another form. For instance, in one example, the website may ask users during or after the checkout process whether they would like to share information about their purchase. The user may opt to share such information with a recipient. Examples may include information about a product or a service, about a merchant, about cost, and/or about a sale. Further, the share button 200 is in no way limited to sharing with particular recipients. The user may in some examples identify a group with which the user wishes to share information. Yet further, the share button 200 may appear in a variety of different locations within a website, such as in order histories, keyword searches, category drill-down searches, advertisements, and product reviews, for example.

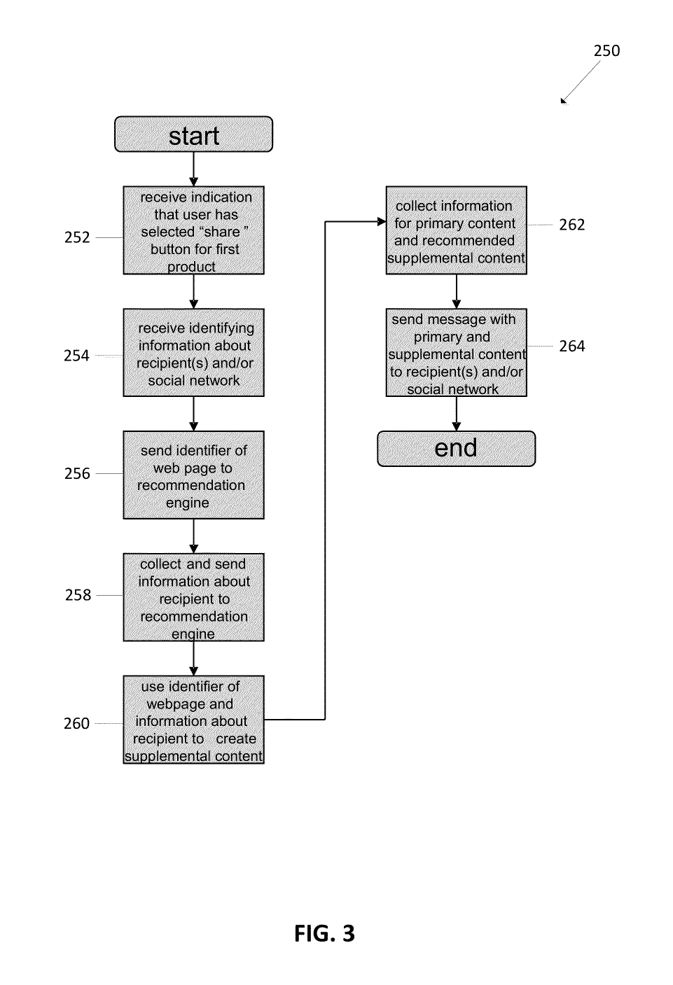

With reference now to FIG. 3, an example method 250 is shown through which the system 100 identifies supplemental content to include with the primary content of webpages that are shared by users. It goes without saying that the steps shown in FIG. 3 need not necessarily be performed in the order shown. Likewise, the steps shown in FIG. 3 are merely example steps. In many other examples, one or more of these steps may be omitted or performed in an entirely different way. In short, the present disclosure contemplates a multitude of ways in which the system 100 can identify supplemental content to be included in messages sharing webpages.

Continuing with the example webpage 190, the example method 250 of FIG. 3 includes a step 252 of receiving an indication that a user has selected the share button 200 on the webpage 190. As disclosed above and as represented by a step 254 in FIG. 3, the system 100 then receives information from the user that identifies one or more recipients with which the user wishes to share the webpage 190. In some examples, the recipient may be another user of the website. In other examples, though, the recipient may have never used the website. Recipients can include virtually any colleague, friend, family member, group, and/or the like. In addition or in the alternative, the user may choose to share the webpage 190 generally, such as by posting to a social network.

The method 250 continues with a step 256, wherein the system 100 sends an identifier that is associated with the webpage 190 and/or the content on the webpage 190 as a first input to a recommendation engine. Based on the content of the webpage 190 in this example, the identifier may be a SKU number of the drywall screw shown in FIG. 2. In a step 258, the system 100 collects and sends all available information about the recipient(s) as a second input to the recommendation engine, which in this example is machine readable instructions stored on non-transitory media and executable on a processor such as, for instance, the CPU 110. Such information may include contact information for the recipient, but typically includes personal information, which is more than contact information alone. In examples where the recipient is also a user of the website, information previously stored about the recipient may also be collected from the repository 108 associated with the content server 106 of the website. Such information, as disclosed in detail above, may have been acquired from the recipient's prior web browsing sessions where events were recorded, content was accessed, and/or products or services were purchased. In examples where the recipient is not a user of the website or where the recipient is not immediately identifiable, the system 100 may use other known methods of collecting information about the recipient, such as by utilizing a data collection agency, performing an Internet search, or obtaining information from an ad network, for instance. In still other examples where the user of the website wishes to share the webpage 190 generally, such as on a social networking site, for instance, the system 100 may acquire any type of information available about or from the social networking site to be input to the recommendation engine. Thus, to create supplemental content for a message sharing the webpage 190, as represented at a step 260 in the example method 250, the system 100 may use the identifier of the webpage 190 and any information available about the recipient(s) or social networking site as input to the recommendation engine.

While the recommendation engine may be implemented in a number of ways, one example methodology is based on a “point” system, where points are “assigned” to each potential product being considered for recommendation. It should be understood that although products are used in many of the examples disclosed herein, the present disclosure contemplates many if not all of the same techniques in connection with services. Nonetheless, because vendors that offer a variety of product typically classify each product into categories, sub-categories, and the like, as disclosed more fully in U.S. patent application Ser. No. 13/731,291, entitled “Systems and Methods for Providing Navigation Tendencies to Users of a Website,” which is hereby incorporated by reference in its entirety, one example way to assign points to products is based on each product's classification, namely, whether a given product is classified in the same category, sub-category, etc. as a product that is being shared. For instance, a product within the same category as the shared product may be assigned one point, while a product within the same sub-category as the shared product may be assigned two points because that product is more related to the shared product.

Moreover, the recommendation engine may identify supplemental content differently depending on whether the system 100 identifies the recipient of the message as a user of the website. For recipients that have not used the website previously or where the system is unable to identify the recipient, the system 100 may compute a number of factors that assist in determining the supplemental content to display in a message sharing the webpage 190. For example, for each product a vendor offers, the system 100 may compute a percentage of customers that have purchased that product when purchasing the drywall screw shown on the webpage 190. If the recommendation engine has allotted ten points to this factor and seventy percent of customers purchase a particular product, that particular product would be assigned seven points (i.e., 70% of 10 points). As still another example factor, in an effort to identify a correlation between the recipient and a product or category of product offered by the website, the system 100 may perform a keyword search of the information collected about the recipient, with the keywords originating from the names, categories, and specifications of products or services that the website offers. In one example the correlation of keywords may be represented as a percentage. For instance, if the information collected about the recipient indicates that the recipient owns or is employed by a lumber yard, the engine may identify a thirty-two percent correlation between the keyword “lumber” and a wheeled lumber cart offered by the website, or a seventeen percent correlation between the keyword “lumber” and a commercial-grade table saw offered by the website. The percentage correlation may likewise be converted to points in examples where the recommendation engine uses a point system.

Still another example factor concerns the percentage of users of a website that view a particular product in the same browsing session as viewing the shared product. For example, if ninety percent of users of the website view Product A and Product B during the same browsing session, the system 100 may be more likely to recommend Product A as supplemental content when Product B is shared, and vice versa. Further, the likelihood of Product A being recommended may increase when compiled data shows that Product A is frequently viewed immediately before or after Product B, as opposed to merely within the same browsing session. As those having ordinary skill will recognize, these factors are merely examples, and the present disclosure contemplates a host of factors that the recommendation engine may consider.

Depending on the results of factors such as these, the recommendation engine may be configured to identify a product that the recipient is most likely to purchase in combination with the drywall screw, which is the focus of the main content being shared with the recipient. In other examples, however, the recommendation engine may be configured to identify two, three, or more products that the recipient is most likely to purchase. In still other examples, the supplemental content may be split into various categories. In one such example, the supplemental content includes three categories: a first category for products that are necessary to use the shared product (e.g., coffee filters for a coffee machine), a second category of products that are optional accessories for the shared product (e.g., a water purifying insert for the coffee machine), and a third category of products that are recommended for the shared product (e.g., a coffee mug).

For recipients that have used the website previously, the system 100 may consider the example factors mentioned above, as well as additional factors to identify supplemental content to be included in a message sharing the webpage 190. Because the system 100 has the ability to record virtually every interaction between a user and the website, the recommendation engine may also consider factors based on a recipient's prior interactions, a record of which may be stored in the repository 108 associated with the content server 106. Example interactions may involve the recipient's prior purchase history or prior browsing history with the website. More particularly, examples of browsing history, as set forth more fully above and in U.S. patent application Ser. No. 13/774,483, entitled “Systems and Methods for Providing Website Browsing History to Repeat Users of a Website,” which is hereby incorporated by reference in its entirety, may include quantity of prior views for a product or service, searches of the website previously requested by the recipient, website menus previously accessed, and products or services saved to a wish list, for instance.

Therefore, the system 100 may assign points to a product based on the recipient's browsing history or purchase history relative to the product. For example, a product being considered for recommendation may be assigned three points if the recipient previously viewed that product, five points if the recipient previously placed that product in an electronic shopping cart, or seven points if the recipient previously purchased that product. As a further example, all products within a sub-category of products may be assigned two points if the recipient has previously spent more than two minutes navigating within that sub-category. Based on the assignment of points such as in these examples, the recommendation engine may identify one or more products that have been assigned the most points. Thus, a product that has been assigned points under numerous factors has a high likelihood of being recommended. For instance, a strong candidate for recommendation is a product that the recipient has previously viewed, that the recipient has previously purchased, and is frequently purchased by others in combination with the shared product.

Where a message regarding the shared webpage 190 is directed to a social network generally, rather than particular individuals, the recommendation engine may consider factors similar to those for non-users of the website. However, in some examples, the recommendation engine may take into account that the message concerning the webpage 190 is being directed to a more general audience. As such, the recommendation engine may be configured to identify more generalized and/or more popular products or services so as to increase the likelihood of “reaching” a potential customer.

As data is compiled over time, the system 100 may in some examples begin to optimize the weight given to certain factors. For example, compiled data may indicate that prior purchase history is three times as indicative of future purchases than is the degree of correlation between the recipient's background and keywords throughout the website. Thus the system 100 may attribute three times as many points to the purchase history factor than to the keyword correlation factor. In some examples, weighting occurs based on compilations of data for all users. In other examples and where a sufficient amount of data has been compiled, weighting occurs based solely on data compiled for a specific user and/or recipient.

The recommendation engine may also consider cost and typical ordered quantities of potential products or services to be included in the supplemental content. To illustrate, if the recommendation engine computes that supplementing a message with a link to Product A is slightly more likely to result in a sale than would a link to Product B, but Product B is more expensive than Product A or will likely be purchased in a higher quantity than Product A—then the recommendation engine may ultimately identify content associated with Product B to be included in the message sharing the webpage 190.

In some examples, however, the supplemental content identified is not necessarily an advertisement for a complementary product, particularly in instances where the recommendation engine determines that the supplemental content is only loosely associated with the primary content or is highly unlikely to result in a sale or an additional sale. In these cases, the supplemental content may include content from the content server and/or the repository 108 such as, for example, news, events, how-to guides, part manuals, instruction manuals, and/or other information associated with the primary content. For instance, the recommendation engine may identify information about a Red Cross training event as supplemental content for primary content concerning first-aid equipment or safety gear. As a further example, where a user of the website shares a webpage regarding a circular saw with a recipient, the recommendation engine may identify a user manual for the circular saw as well as a printed publication regarding minimizing exposure to sawdust as supplemental content to be provided to the recipient.

Still referring to FIG. 3, the example method 250 additionally includes a step 262 where the system 100 collects information to be assembled in a message to the recipient(s) and/or social network. The primary content of the message is the webpage 190 being shared with the recipient, which may be displayed in virtually any known format. Further, the system 100 may also collect the supplemental content to include in the message based on the content identified by the recommendation engine. The primary and supplemental content may each be in the form of, for instance, a hyperlink to the webpage 190, a full or reduced version of the webpage 190, catalog pages, links to catalog pages, and/or a subset of content from the webpage 190. In some examples, a catalog page may be a pre-existing webpage or PDF that contains the primary product being shared, product recommendations (i.e., in this instance not based on the recipient's information), required products, and optional products. Further, for recipients that have used the website previously, the system 100 may generate personalized information for the recipient to the extent it is known. Such personalized information may not only be used to provide recipients with customized pricing information, but may also be used to restrict items where the recipient needs training or certification, exclude products that cannot be shipped to the recipient's address for one reason or another (e.g., not-for-export products), and/or exclude products that are age-inappropriate.

Similarly, the system 100 may in still other examples have filters that regulate the information that may be included as supplemental content. By way of example, the system 100 may preclude information about a product that has been temporarily recalled from being distributed as supplemental content. Much the same, if the system 100 identifies the recipient as being associated with a first company, the system 100 may preclude the inclusion of supplemental information regarding a product offered by a second company that is a competitor to the first company. In some examples, the filters that are created for the supplemental content may be based on recent themes and/or trends circulating via social media.

As represented by a step 264, the system 100 sends the message with the primary and supplemental content to the recipient(s) and/or social network via the medium chosen by the user of the website. Those having ordinary skill in the art will appreciate that the extent and format of the primary and supplemental content may vary depending on the medium through which the message is distributed. Also, in examples where the user copies himself on shared messages, the system 100 may include supplemental content targeted to that particular user using the same or similar techniques disclosed above.

In one example, the supplemental content included in a shared message may be updated when a recipient views the supplemental content based on cookies stored locally on the recipient's user processing device 102. For instance, if the system 100 detects cookies or other stored information on the recipient's user processing device 102 that indicate that the recipient viewed a particular belt sander last week on the website sending the message, the system 100 may replace a recommended product with information regarding the belt sander.

While the example webpage 190 concerns a product, the present disclosure is in no way limited to vendors of product. Accordingly, those of ordinary skill will appreciate that the present disclosure can be utilized in a wide variety of contexts. For example, users of websites that broadcast news frequently share stories with one another. The website could include as supplemental content news stories related to the shared story, news stories having a strong keyword correlation with information collected about the recipient, or new stories related to stories that have been previously viewed by the recipient in the past, for example. As a further example, aggregator restaurant websites could advertise restaurants and specials of restaurants related to a restaurant shared in a message. Still further, websites selling or hosting music or videos could include supplemental content related to a shared song or video, or content based on the recipient's prior downloads, streams, etc. Likewise, daily deal websites could advertise comparable deals in the supplemental content in a shared message, or deals related to deals that the recipient has previously purchased. In addition, in some examples, the user of the website may in fact be a customer service representative or other employee of the merchant operating the website. Thus, the customer service representative or other employee could utilize the recommendation engine when sending information regarding a product to a recipient such as a prospective customer, for example. As disclosed above, in still other examples, the user could be an employee of a company unrelated to the merchant operating the website and the recipient could be an employee of yet another company or a supplier to the company with which the user is associated.

In some examples, the supplemental content need not relate to a product or service offered by the website through which a user shares content. In this way, the website can advertise related goods or services, most likely of a non-competitor, in a message sharing content from the website. In return, the website may negotiate a royalty agreement with third-party providers of those good or services where the website receives a kickback for each advertisement and/or for each referral that results in a purchase.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

I claim:

1. A non-transitory computer readable media having stored thereon instructions which, when executed by a computer, perform steps comprising:
providing a webpage of a website, the webpage having content and a selectable share indicator, wherein an identifier is associated with the content of the webpage;
prompting a user of the webpage to enter at least one of identifying information for a recipient or an identity of a social network in response to the share indicator being selected;
collecting and providing to a recommendation engine the identifier associated with the content of the webpage and information about at least one of the recipient or the social network, wherein information about the recipient includes personal information for the recipient;
executing the recommendation engine on a processor to identify supplemental content; and
sending a message to at least one of the recipient or the social network that includes at least a portion of the content of the webpage and the supplemental content identified by the recommendation engine.

2. A non-transitory computer readable media as recited in claim 1, wherein the recommendation engine identifies the supplemental content at least in part by costs of goods or services being recommended.

3. A non-transitory computer readable media as recited in claim 1, wherein the recommendation engine is optimized over time based on compiling data about purchases.

4. A non-transitory computer readable media as recited in claim 1, wherein the recommendation engine uses at least in part a categorization system of the website to identify the supplemental content to be included in the message.

5. A non-transitory computer readable media as recited in claim 1, wherein the information about the recipient is acquired at least in part from prior interactions between the recipient and the website.

6. A non-transitory computer readable media as recited in claim 5, wherein the prior interactions between the recipient and the website comprise a purchase history of the recipient.

7. A non-transitory computer readable media as recited in claim 5, wherein the recommendation engine uses at least in part a categorization system of the website to identify the supplemental content to be included in the message.

8. A non-transitory computer readable media as recited in claim 5, wherein the supplemental content is identified at least in part by comparing keywords from the website to the personal information about the recipient.

9. A non-transitory computer readable media as recited in claim 5, wherein the supplemental content is based on cookies local to a processing device of the recipient.

10. A non-transitory computer readable media as recited in claim 5, wherein the content of the webpage comprises a first product offered by the website, wherein the supplemental content comprises a second product of a type that is required to use the first product and a third product that is compatible with the first product but not required to use the first product.

11. A non-transitory computer readable media as recited in claim 10, wherein the supplemental content is identified at least in part by identifying products that customers of the website are purchasing in combination with the first product.

12. A non-transitory computer readable media having stored thereon instructions which, when executed by a computer, perform steps comprising:
providing a webpage of a website, the webpage having content and a share indicator, wherein an identifier is associated with the content of the webpage;
prompting a user of the webpage to enter identifying information for a recipient in response to the share indicator being selected;
collecting information about the recipient, wherein the information about the recipient includes contact information and personal information for the recipient;
identifying supplemental content based on the identifier associated with the content of the webpage and the information about the recipient; and
sending a message to the recipient that includes at least a portion of the content of the webpage and the supplemental content.

13. A non-transitory computer readable media as recited in claim 12, wherein identifying the supplemental content further comprises using a categorization system of the website to identify the supplemental content at least in part to be included in the message.

14. A non-transitory computer readable media as recited in claim 12, wherein the information about the recipient is acquired at least in part from prior interactions between the recipient and the website, wherein the prior interactions between the recipient and the website comprise at least one of a purchase history or a browsing history of the recipient.

15. A non-transitory computer readable media as recited in claim 12, wherein the content of the webpage comprises a product offered by the website, wherein the supplemental content comprises a first accessory to the product, the accessory being of a type that is required to use the product, wherein the supplemental content comprises a second accessory to the product, the second accessory being of a type that is not required to use the product.

16. A non-transitory computer readable media as recited in claim 15, wherein the supplemental content is identified at least in part by identifying products that customers of the website are purchasing in combination with the product.

17. A non-transitory computer readable media having stored thereon instructions which, when executed by a computer, perform steps comprising:
providing a webpage of a website, the webpage having content and a share indicator, wherein an identifier is associated with the content of the webpage;
receiving identifying information for a recipient in response to the share indicator being selected;
collecting information about the recipient based on the identifying information, wherein the information collected about the recipient includes contact information and personal information;
identifying supplemental content based on the identifier associated with the content of the webpage and the information collected about the recipient; and
sending a message to the recipient that includes at least a portion of the content of the webpage and the supplemental content.

18. A non-transitory computer readable media as recited in claim 17, wherein the information about the recipient is collected at least in part from prior interactions between the recipient and the website.

19. A non-transitory computer readable media as recited in claim 17, wherein the supplemental content is identified at least part based on cost of products offered by the website.

20. A non-transitory computer readable media as recited in claim 17, wherein the supplemental content is identified at least in part by identifying combinations of products that customers have purchased from the website.
